(19) United States
(12) Patent Application Publication
(10) Pub. No.: US 2019/0210499 A1
(43) Pub. Date: Jul. 11, 2019

(54) ARMREST ARRANGEMENT FOR A MOTOR VEHICLE SEAT

(71) Applicants: Jan BODDENBERG, Köln (DE); Hartmut BOHLKE, Wuppertal (DE); Andreas GÖBBELS, Kürten (DE); Tanja PINK, Wuppertal (DE); Wolfgang SITZLER, Wuppertal (DE); Bogdan TUTELEA, Leichlingen (DE)

(72) Inventors: Jan BODDENBERG, Köln (DE); Hartmut BOHLKE, Wuppertal (DE); Andreas GÖBBELS, Kürten (DE); Tanja PINK, Wuppertal (DE); Wolfgang SITZLER, Wuppertal (DE); Bogdan TUTELEA, Leichlingen (DE)

(21) Appl. No.: 16/241,173

(22) Filed: Jan. 7, 2019

(30) Foreign Application Priority Data
Jan. 8, 2018 (DE) 10 2018 200 187.1

(51) Int. Cl. B60N 2/75

(52) U.S. Cl. CPC B60N 2/767; B60N 2/757

(57) ABSTRACT

Armrest arrangement having a positionally fixed carrier structure, an armrest structure pivotably displaceable relative thereto about a pivot axis between a functional position and a non-use position. An inclination adjusting device is assigned to the armrest structure and has an adjustment element which, in the functional position, is supported indirectly on the carrier structure and which is, with respect to an adjustment axis, movable relative to the armrest structure such that the inclination of the armrest structure relative to the carrier structure in the functional position is adjustable by an adjustment movement of the adjustment element. The adjustment axis is oriented parallel to the pivot axis, wherein the at least one adjustment element is mounted for rotation about the adjustment axis and is supported on a guide track assigned to the carrier structure.

### CROSS-REFERENCE TO RELATED APPLICATIONS

This claims priority from German Application No. 10 2018 200 187.1, filed Jan. 8, 2018, the disclosure of which is hereby incorporated by reference in its entirety.

### RELATED FIELD

The invention relates to an armrest arrangement for a motor vehicle seat, having a positionally fixed carrier structure, having an armrest structure which is pivotably displaceable relative to the carrier structure about a pivot axis between a functional position and a non-use position, having an inclination adjusting device which is assigned to the armrest structure and which has at least one adjustment element which, in the functional position, is supported at least indirectly on the carrier structure and which is, with respect to an adjustment axis, movable relative to the armrest structure such that the inclination of the armrest structure relative to the carrier structure in the functional position is adjustable by means of an adjustment movement of the adjustment element.

### BACKGROUND

An armrest arrangement of said type is known from DE 2016 220 501 A1. The known armrest arrangement has a positionally fixed carrier structure, which in a state of intended use is mounted, fixedly with respect to the vehicle, on the motor vehicle seat. Furthermore, an armrest structure is provided which is supported on the carrier structure so as to be pivotable about a pivot axis between a functional position and a non-use position. In the functional position, a longitudinal axis of the armrest structure is oriented substantially horizontally. In the non-use position, the longitudinal axis of the armrest structure is oriented substantially vertically. The armrest structure is assigned an inclination adjusting device, by means of which an inclination of the armrest structure relative to the carrier structure in the functional position is adjustable. For this purpose, the inclination adjusting device has an adjustment element in the form of a support member. The support member is, in the functional position, supported at a face end side on a stop of the positionally fixed carrier structure. For the adjustment of the inclination, the support member is guided in the armrest structure so as to be longitudinally movable along an adjustment axis extending transversely with respect to the pivot axis and parallel to the longitudinal axis of the armrest structure. A longitudinal movement of the support member in the direction of the stop results in a more intensely upwardly directed inclination of the armrest structure. A longitudinal movement in the opposite direction results in a reduced inclination.

### SUMMARY

It is an object of the invention to create an armrest arrangement of the type mentioned in the introduction which has improved characteristics in relation to the prior art.

This object is achieved in that the adjustment axis is oriented parallel to the pivot axis, wherein the at least one adjustment element is mounted so as to be rotatable about the adjustment axis and is supported on at least one guide track assigned to the carrier structure. By means of the solution according to the invention, it is possible in particular for a structural space saving to be permitted with regard to the arrangement and/or design of the inclination adjusting device. This is because, by means of the adjustment axis oriented parallel to the pivot axis in accordance with the invention, it is the case in particular that structural space is saved in a longitudinal direction of the armrest arrangement. Furthermore, owing to the rotational mobility of the adjustment element according to the invention, a space-consuming linear movement of the adjustment element relative to the armrest structure can be avoided, whereby structural space can be additionally saved. The adjustment element is thus a rotational adjustment element which is preferably mounted rotatably on the armrest structure. In relation to the armrest structure, the adjustment element is substantially linearly non-displaceable, wherein the adjustment element may exhibit a certain degree of longitudinal play in the axial direction of the adjustment axis. The guide track for supporting the adjustment element may be formed directly on the carrier structure. Alternatively, and preferably, the guide track may be formed on a component manufactured separately from the carrier structure.

The solution according to the invention is particularly advantageously suitable for a driver's seat and/or front passenger seat of a passenger motor vehicle. Irrespective of this, the solution according to the invention may also be used for a motor vehicle seat arranged in the rear region of a passenger motor vehicle, or for a rear seat bench of a passenger motor vehicle. The armrest arrangement according to the invention may however also be used for the equipment of other motor vehicles, and is not restricted to passenger motor vehicles or motor vehicles in general.

In one embodiment of the invention, the guide track has a longitudinal extent concentric with respect to the pivot axis. Since the adjustment axis is oriented parallel to the pivot axis and the inclination adjusting device is assigned to the armrest structure, the adjustment element moves on a circular-arc-shaped movement path during an inclination adjustment. This circular-arc-shaped path is concentric in relation to the pivot axis. Accordingly, the guide track for supporting the adjustment element has a longitudinal extent concentric with respect to the pivot axis, which permits particularly advantageous support of the adjustment element.

In a further embodiment of the invention, the adjustment element has a spur-toothed spur gear portion, and the guide track has a tooth rack portion. Accordingly, in this embodiment of the invention, the adjustment element is supported in positively locking fashion on the guide track. The inclination adjustment of the armrest structure is effected by means of a positively locking transmission of force between the spur gear portion and the toothed rack portion.

Here, the rotational movement of the adjustment element is, by means of support of the spur gear portion on the toothed rack portion, converted into a pivoting movement of the armrest structure relative to the carrier structure. The toothed rack portion advantageously has a longitudinal extent concentric with respect to the pivot axis. The spur gear portion may be in the form of a spur gear with an encircling toothing. Alternatively, the spur gear portion may be in the form of a toothing which is coherent in the circumferential direction but not of fully encircling configuration. This embodiment of the invention permits a particularly reliable and robust transmission of force for the inclination adjustment of the armrest structure.

In a further embodiment of the invention, the adjustment element has a stop portion and the guide track has counterpart stop portions arranged at opposite face end regions. The stop portion of the adjustment element and the counterpart stop portions of the guide track serve for delimiting an adjustment range of the inclination adjustment in positively locking fashion. In a first end position of the inclination adjustment, the stop portion abuts against a first of the counterpart stop portions. In a second end position of the inclination adjustment, the stop portion abuts against a second of the counterpart stop portions. If the adjustment element has a spur-toothed spur gear portion, it is advantageous if the stop portion is in the form of a non-toothed circumferential wall portion, which preferably protrudes in a radial direction, of the adjustment element. The stop portion may thus have for example a circular-segment-like cross-sectional shape. The counterpart stop portions are preferably each formed with an outer wall contour complementary with respect to the stop portion.

In a further embodiment of the invention, the stop portion is, with respect to the adjustment axis, arranged axially offset with respect to the spur gear portion, and the counterpart stop portions are arranged equally axially offset with respect to the toothed rack portion. In this embodiment of the invention, the adjustment element may have a spur gear which is toothed over its entire circumference. The stop portion is in this case formed so as to be axially offset with respect to and thus separate from the spur gear. The counterpart stop portions are arranged equally axially offset with respect to the toothed rack portion of the guide track. By means of this embodiment of the invention, it is possible in particular to achieve an enlarged adjustment range of the inclination adjusting device.

In a further embodiment of the invention, the inclination adjusting device has a blocking device by means of which the adjustment element can be blocked so as to be rotationally fixed about the adjustment axis, and/or the inclination adjusting device has a drive device by means of which the adjustment element is subjected to a torque for the displacement along the guide track. The blocking device may be operatively connected in non-positively locking and/or positively locking fashion to the adjustment element and/or to a bearing axle of the adjustment element. The blocking device preferably acts on the bearing axle of the adjustment element. The blocking device may for example have a wrap spring, a brake band, a locking geometry or the like which, in a blocked state, effects blocking of the adjustment element such that it is rotationally fixed with respect to the adjustment axis. The drive device is preferably operatively connected to the bearing axle of the adjustment element. The drive device may have a mechanical spring drive. The spring drive is advantageously preloaded during an adjusting movement of the armrest structure performed by a user. Spring energy that is stored in the process can be utilized to displace the adjustment element along the guide track after a release of the blocking device, and to thus adjust the inclination of the armrest structure.

In a further embodiment of the invention, two adjustment elements are provided which are spaced apart axially along the adjustment axis and which are each supported on a guide track. The adjustment elements and the guide tracks are preferably arranged mirror-symmetrically with respect to a central longitudinal plane of the armrest arrangement. If the armrest arrangement is subjected to load in the intended manner in the functional position, it is possible by means of such an arrangement of the adjustment elements and guide tracks to realize, in particular, a reduced loading of the inclination adjusting device. Overloading of and thus damage to the inclination adjusting device is avoided in this way.

In a further embodiment of the invention, a support structure is provided which, in the functional position, is supported on the carrier structure and on which the at least one guide track is formed, wherein the support structure is pivotable jointly with the armrest structure from the functional position into the non-use position. Accordingly, the support structure serves for the indirect support of the armrest structure on the carrier structure. The support structure is—at any rate in the functional position —supported at one end on the carrier structure. The armrest structure is in turn supported on the support structure. The adjustment of the inclination of the armrest structure relative to the carrier structure is realized here by means of an adjustment of the inclination of the armrest structure relative to the support structure. For this purpose, the adjustment element of the inclination adjusting device is supported on the guide track which, although assigned to the carrier structure, is formed on the support structure. If two adjustment elements and therefore two guide tracks are provided, it is advantageous if the support structure is of symmetrical form with respect to a central longitudinal plane of the armrest arrangement. Here, the two guide tracks may preferably be formed on mutually opposite side walls of the support structure.

In a further embodiment of the invention, an arresting device is provided which is assigned to the armrest structure and by means of which the armrest structure is, at least in the functional position, arrested on the carrier structure. The arresting device serves primarily for the crash safety of the armrest arrangement. Since the armrest structure is, in the functional position, arrested on the carrier structure by means of the arresting device, the armrest structure is prevented from being thrown from the functional position into the non-use position in an uncontrolled manner as a result of an accident. In this way, a risk of injury posed by the armrest arrangement can be reduced. The arresting device may preferably have a pawl or some other detent geometry which is connected to the armrest structure and which is locked to the carrier structure in the functional position.

In a further embodiment of the invention, a control device is provided which is assigned to the arresting device and which is designed such that the arresting device can be released by means of an adjustment movement of the adjustment element. It is achieved in this way that, in the event of an adjustment of the inclination performed by a user, that is to say during an adjustment movement of the adjustment element, the arresting device is, as it were, automatically released. Separate manual operation of the arresting device for the purposes of releasing the armrest structure from the carrier structure is thus not necessary. The control device preferably has a sliding-block guide and a sliding-block element, which are operatively connected to the arresting device. Here, the sliding-block element may be assigned to the support structure, and the sliding-block guide may be assigned to the armrest structure, or vice versa. In the case of a relative movement, caused by an inclination adjustment, between the armrest structure and the support structure, the sliding-block mechanism controls the arresting device such that the latter releases the armrest structure from the carrier structure.

### BRIEF DESCRIPTION OF THE DRAWINGS

Further advantages and features of the invention will emerge from the claims and from the following description of a preferred exemplary embodiment of the invention, which is illustrated on the basis of the drawings.

FIG. 1 shows, in a schematic perspective illustration, an embodiment of an armrest arrangement according to the invention, which is arranged in a motor vehicle interior compartment,

FIG. 2 shows, in a partially cut-away schematic perspective illustration, the armrest arrangement as per FIG. 1 in a functional position,

FIG. 3 shows, in a schematic side view omitting some components, the armrest arrangement as per FIGS. 1 and 2, with different inclination positions being superposed in the drawing,

FIG. 4 shows, in a further schematic perspective illustration, the armrest arrangement as per FIGS. 1 to 3 in the functional position,

FIG. 5 shows, in a partially cut-away schematic perspective illustration, the armrest arrangement as per FIGS. 1 to 4 in an intermediate position pivoted out of the functional position in the direction of a non-use position,

FIG. 6 shows, in an enlarged, partially cut-away detail illustration, the armrest arrangement as per FIGS. 1 to 5 in the region of an inclination adjusting device,

FIG. 7 shows the armrest arrangement as per FIGS. 1 to 6 in a schematic cross section VII as per FIG. 6,

FIGS. 8 and 9 show, in each case in a partially cut-away schematic side view, the armrest arrangement as per FIGS. 1 to 7 in the region of an arresting device in a first pivoting position (FIG. 8) and in a second pivoting position (FIG. 9), and

FIGS. 10 and 11 show, in each case in a partially cut-away schematic side view, the armrest arrangement as per FIGS. 1 to 9 in the region of the arresting device in a first inclination position (FIG. 10) and in a second inclination position (FIG. 11).

### DETAILED DESCRIPTION

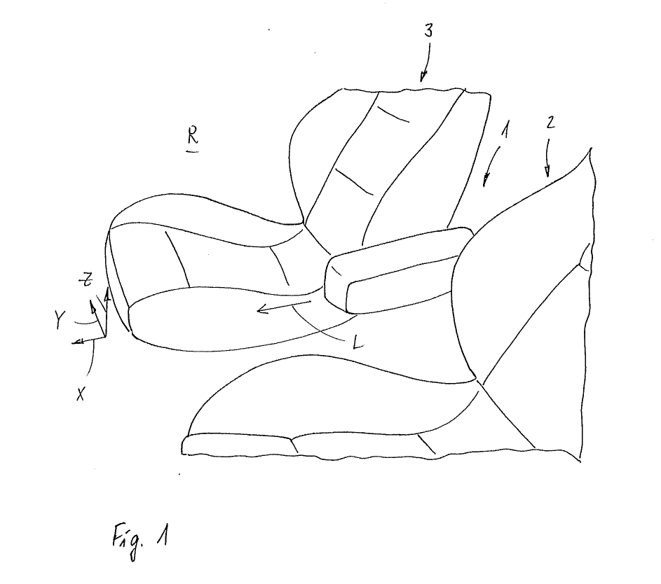

As per FIG. 1, an armrest arrangement 1 is arranged in a motor vehicle interior compartment R and assigned to a motor vehicle seat 2. The armrest arrangement 1 is arranged in a transverse direction Y of the motor vehicle interior compartment R between the vehicle seat 2, which in the present case is a driver's seat, and a further motor vehicle seat 3, which in the present case is a front passenger seat. In another embodiment, the armrest arrangement 1 may be arranged in a rear region of the motor vehicle interior compartment R and assigned to a rear seat bench (not shown in any more detail).

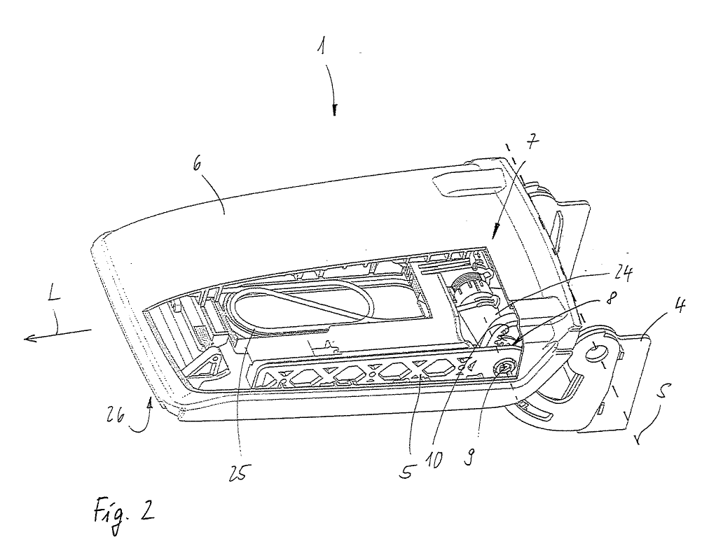

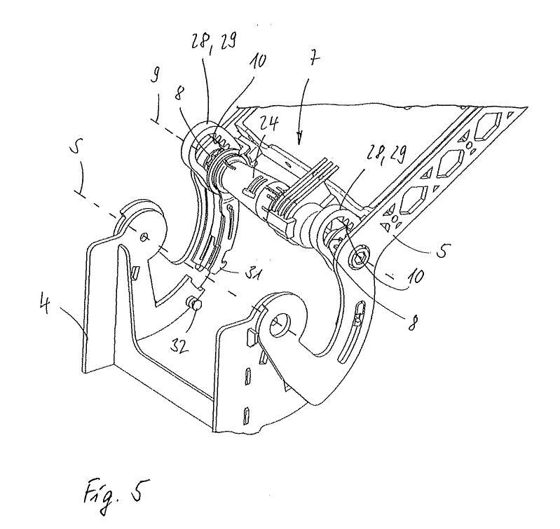

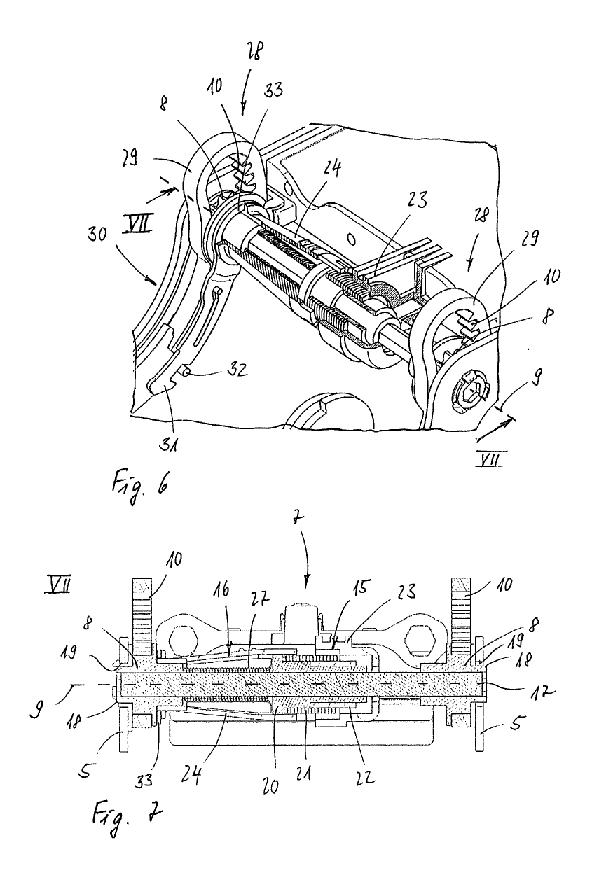

As can be seen in particular on the basis of FIGS. 2 to 5, the armrest arrangement 1 has a carrier structure 4. When installed in the intended manner in the motor vehicle interior compartment R, the carrier structure 4 is, in a manner that is basically known, installed so as to be fixed with respect to the vehicle, and thus positionally fixed. The armrest arrangement 1 furthermore has an armrest structure 5 which is pivotably displaceable relative to the carrier structure 4 about a pivot axis S between a functional position and a non-use position. In the functional position, a longitudinal axis L of the armrest structure 5 is oriented substantially parallel to a longitudinal direction X (FIG. 1) of the motor vehicle interior compartment R and thus substantially horizontally. In the non-use position, which is not illustrated in any more detail in the drawings, the longitudinal axis L of the armrest structure 5 is oriented substantially parallel to a vertical direction Z (FIG. 1) of the motor vehicle interior compartment R and thus substantially vertically. The armrest structure 5 is equipped with a trim arrangement 6 (FIG. 2), which in turn may be lined with a lining (not shown in any more detail), which may be manufactured for example from a textile lining material or from leather. In the functional position, the armrest structure 5 serves for example for supporting a forearm, resting on the trim arrangement 6, of a vehicle occupant situated on the driver's seat 2 or the front passenger seat 3. For ergonomic reasons, the inclination of the armrest structure 5 relative to the carrier structure 4 in the functional position—and thus the inclination of the armrest structure 5 relative to the longitudinal direction X—is adjustable. For this purpose, an inclination adjusting device 7 is provided which is assigned to the armrest structure 5. The inclination adjusting device 7 is shown in detail in particular in FIGS. 6 and 7 and has at least one adjustment element 8 which, in the functional position, is supported at least indirectly on the carrier structure 4 and which is, with respect to an adjustment axis 9, movable relative to the armrest structure 5 such that the inclination of the armrest structure 5 relative to the carrier structure 4 in the functional position is adjustable by means of an adjustment movement of the adjustment element 8.

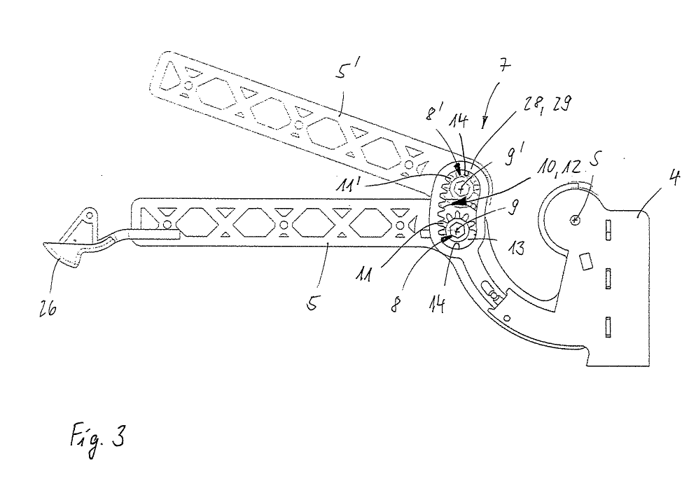

It can be seen in particular from FIG. 3 that the adjustment axis 9 is oriented parallel to the pivot axis S. Here, the at least one adjustment element 8 is mounted so as to be rotatable about the adjustment axis 9 and is supported on at least one guide track 10 assigned to the carrier structure 4.

FIG. 3 shows the armrest structure 5 in the functional position in two states of inclination, which are superposed in the drawing, relative to the carrier structure 4. In the lower state of inclination in relation to the plane of the drawing in FIG. 3, the armrest structure 5 is oriented substantially horizontally. For better distinguishability, the structural elements of the armrest arrangement 1 in the upper state of inclination are denoted by reference designations with an apostrophe suffix. In the upper state of inclination, the armrest structure 5′ assumes an obliquely upwardly inclined position relative to the carrier structure 4. Here, the adjustment of the inclination is performed by means of a transmission of force between the adjustment element 8, 8′ of the inclination adjusting device 7 and the guide track 10, which is assigned to the carrier structure 4. For this purpose, the adjustment element 8, 8′ is driven about the adjustment axis 9, 9′ in a manner yet to be described in more detail. For the adjustment of the inclination proceeding from the lower inclination position in FIG. 3 into the upper inclination position, the adjustment element 8 is rotated counterclockwise about the adjustment axis 9. Here, the adjustment element 8 is supported on the guide track 10 and moves upward relative to the guide track 10. Here, the guide track 10 is supported rotationally fixedly on the carrier structure 4. The armrest structure 5, on which the adjustment element 8 is rotatably mounted, is in this case pulled, as it were, upward by the adjustment element 8 and performs a pivoting movement about the pivot axis S.

As can also be seen from FIG. 3, the guide track 10 has a longitudinal extent concentric with respect to the pivot axis 5. That is to say, the guide track 10 is curved and is arranged so as to be spaced apart from the pivot axis S with a constant radial spacing. In the present case, the guide track 10 extends over an angle of approximately 20°. Accordingly, in the present case, a range of adjustment of the inclination of the armrest structure 5 relative to the carrier structure 4 of approximately 20° is possible.

In the present case, the adjustment element 8 has a spur-toothed spur gear portion 11. Accordingly, the guide track 10 has a toothed rack portion 12 adapted to the spur gear portion 11. During the above-described inclination adjustment of the armrest structure 5, the spur gear portion rolls on the toothed rack portion 12. Owing to the positively locking contact between the spur gear portion 11 and the toothed rack portion 12, the rotational movement of the adjustment element 8 about the adjustment axis 9 is converted into a pivoting movement of the armrest structure 5 about the pivot axis S relative to the carrier structure 4.

As can also be seen in particular from FIG. 3, the adjustment element 8 has a stop portion 13. The stop portion is in the present case in the form of a non-toothed circumferential portion of the adjustment element 8. The spur gear portion 11 thus does not have a continuous spur toothing in a circumferential direction. The guide track 10 has counterpart stop portions 14 which are arranged at opposite face end regions and which are of complementary design with respect to the stop portion 13. The stop portion 13 and the counterpart stop portions 14 thus serve for limiting the inclination adjustment of the armrest structure 5 in positively locking fashion. In the lower inclination position in FIG. 3, the stop portion 13 is abutting against the lower counterpart stop portion 14. In the upper inclination position, the stop portion 13 is abutting against the upper counterpart stop portion 14. Here, during an inclination adjustment, the stop portion 13 rotates jointly with the spur gear portion 11 about the adjustment axis 9. In the present case, for the adjustment of the inclination between the upper and the lower inclination position, a rotational adjustment movement of the adjustment element 8 of only approximately 180° about the adjustment axis 9 is required. To be able to permit a greater adjustment range of the inclination in terms of magnitude, it may be necessary for the spur gear portion 11 and the stop portion 13 to be, with respect to the adjustment axis 9, arranged axially offset with respect to one another. In the case of such a design, the adjustment element 8 may have a spur gear which is fully toothed in encircling fashion in a circumferential direction. The stop portion 13 may in this case be arranged in front of or behind the spur gear so as to be spaced apart therefrom in the axial direction of the adjustment axis 9, and otherwise be designed correspondingly to the stop portion 13 shown in FIG. 3. Accordingly, in the case of such a design, the toothed rack portion 12 may be arranged axially offset with respect to the counterpart stop portions 14.

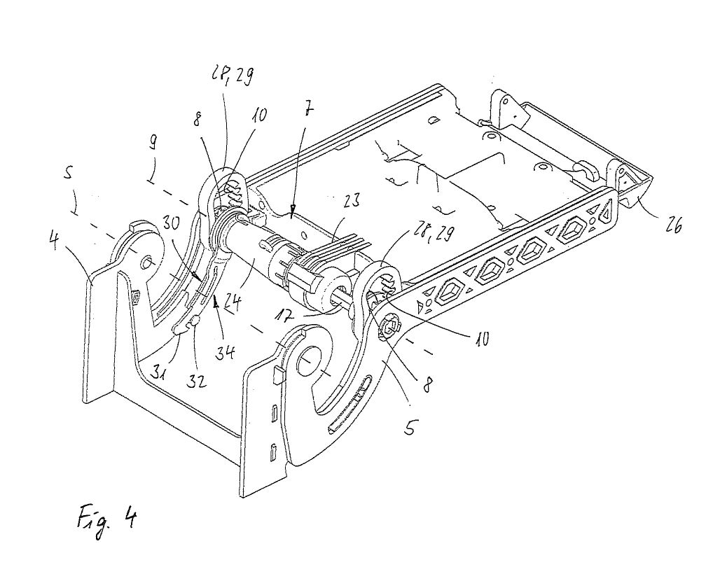

It can be seen from FIGS. 4 to 7 that the armrest arrangement 1 is in the present case of substantially mirror-symmetrical design with respect to a central longitudinal plane. This relates in particular to the carrier structure 4 and the armrest structure 5. In the present case, two adjustment elements 8 are thus provided, which are arranged so as to be axially spaced apart along the adjustment axis 9 and mirror-symmetrical with respect to the central longitudinal plane of the armrest arrangement 1. Each of the adjustment elements 8 is, in the present case, supported on in each case one guide track 10. The adjustment elements 8 are of identical construction with regard to their structural design and function. The same applies to the two guide tracks 10. To avoid repetitions, the disclosure relating to one of the adjustment elements 8 or one of the guide tracks applies correspondingly to the further adjustment element 8 or the further guide track 10 respectively.

It can be seen in particular from FIGS. 6 and 7 that the inclination adjusting device 7 has a blocking device 15. By means of the blocking device 15, the adjustment element 8 can be blocked so as to be rotationally fixed about the adjustment axis 9. Accordingly, by means of the blocking device, the armrest structure 5 can be fixed in a set inclination relative to the carrier structure 4. Furthermore, the inclination adjusting device 7 has a drive device 16 by means of which the adjustment element 8 is subjected to a torque for the displacement along the guide track 10. In the present case, by means of the drive device 16, both adjustment elements 8 are subjected to a torque for the displacement along the respective guide track 10. The construction of the adjustment device 7, and in particular the function of the blocking device 15 and of the drive device 16, will be discussed in more detail below.

The adjustment device 7 has a bearing axle 17 which extends along the adjustment axis 9. The adjustment elements 8 are fixed to mutually opposite face end regions of the bearing axle 17 in a manner which is basically known. The adjustment elements 8 have, in face regions situated at the outside in an axial direction, in each case one journal 18, which is radially fixed in a rotatable manner in each case in a receiving bore 19 of the armrest structure 5. Approximately centrally in the axial direction of the bearing axle 17, there is arranged an intermediate sleeve 20, which is fixed rotationally conjointly to the outer circumference of the bearing axle 17. The blocking device 15 has a wrap spring 21 which is oriented coaxially with respect to the bearing axle 17 and the intermediate sleeve 20. The wrap spring 21 is, at its inner circumference, fixed in portions on an outer circumference of a bushing 22 and in portions on an outer circumference of the intermediate sleeve 20. In a right-hand face end region in relation to the plane of the drawing of FIG. 7, the wrap spring 21 is, in a manner not shown in any more detail, supported rotationally fixedly on a housing 23 of the inclination adjusting device 7. At the other end, the wrap spring 21 is operatively connected to an actuation sleeve 24. The actuation sleeve 24 is oriented coaxially with respect to the bearing axle 17 and can be actuated in rotation by means of a remote unlocking element 25 shown in FIG. 2. The remote unlocking element 25 is, in the present case, a Bowden cable, though this is not imperative. The remote unlocking element 25 is actuatable by means of an actuation button 26 (FIGS. 2 and 3). In the state shown in FIG. 7, the bearing axle 17 is rotationally fixedly blocked by means of the wrap spring 21. A movement of the adjustment elements 8 along the respective guide track 10 is thus prevented. This is because the inner circumference of the wrap spring 21 is operatively connected in non-positively locking fashion to the outer circumference of the intermediate sleeve 20, and the intermediate sleeve 20 is thus indirectly supported rotationally fixedly on the housing 23. To release the blocking device 15, the actuation button 26 is actuated. Via the Bowden cable 25 operatively connected to the actuation button 26, the actuation sleeve 24 is deflected in a circumferential direction. Since said actuation sleeve is at a face end, operatively connected in a manner not shown in any more detail to a spring leg (not illustrated), of the wrap spring 21, the wrap spring 21 is radially expanded. Here, the non-positive locking between the inner circumference of the wrap spring 21 and the outer circumference of the intermediate sleeve 20 is eliminated. As a result, the bearing axle 17 is released in terms of its rotational mobility about the adjustment axis 9, and a movement of the adjustment elements 8 along the guide tracks 10 is ultimately permitted.

To assist the inclination adjustment, the drive device 16 has a torsion spring 27. The torsion spring 27 is operatively connected to the bearing axle 17 and thus indirectly to the two adjustment elements 8. In the lower inclination position of the armrest structure 5 shown in FIG. 3, the torsion spring 27 is preloaded and has the effect of exerting torque in a counterclockwise direction on the adjustment elements 8. If, in this inclination position, the blocking device 15 is released by means of actuation of the actuation button 26 in the manner described above, the exertion of torque on the adjustment elements 8 has the effect of assisting the upward movement of the armrest structure 5 into the upper inclination position.

Furthermore, in the present case, a support structure 28 is provided which, in the functional position, is supported at one end on the carrier structure 4 (cf. for example FIG. 4). The at least one guide track 10 is formed on the support structure 28. The support structure 28 is pivotable together with the armrest structure 5 from the functional position into the non-use position. Like the carrier structure 4 and the armrest structure 5, the support structure 28 is, in the present case, formed mirror-symmetrically with respect to a central longitudinal plane of the armrest arrangement 1. In this respect, the support structure 28 has two support limbs 29 which are arranged oppositely so as to be spaced apart in the axial direction of the adjustment axis 9. In each case one of the guide tracks 10 is formed on each of the support limbs 29. It can be seen from FIG. 4 that the support limbs 29, in the functional position, are supported on the carrier structure 4 in the direction of a pivoting movement of the armrest structure 5 which goes beyond the functional position. It can be seen from FIG. 5 that, during a displacement of the armrest structure 5 proceeding from the functional position, the support limbs 29 are pivotable jointly with the armrest structure 5 in the direction of the non-use position.

To prevent the armrest structure 5 from being thrown from the functional position into the non-use position in an uncontrolled manner for example in the event of an accident, an arresting device 30 is provided. The arresting device 30 has a detent element 31 which, in an arrested state (FIG. 8), is operatively connected to a counterpart detent element 32 arranged on the carrier structure 4. In the present case, the detent element is in the form of a detent lug 31. The counterpart detent element is in the form of a detent pin 32. At a face end region averted from the detent element 31, the arresting device 30 is operatively connected to the bearing axle 17. For this purpose, the arresting device 30 has an eyelet 33 which engages around the bearing axle 17.

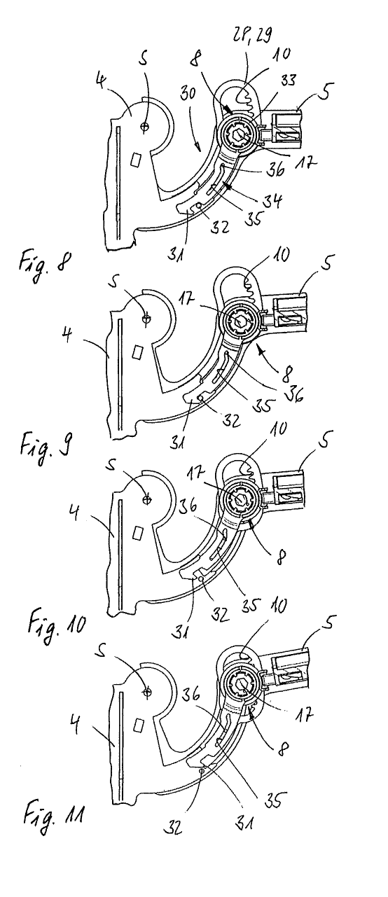

Furthermore, a control device 34 is provided which is assigned to the arresting device 30 and which is designed such that the arresting device 30 can be released by means of an adjustment movement of the adjustment element 8. The functioning of the arresting device 30 and of the control device 34 can be seen in particular from FIGS. 8 to 11. FIG. 8 shows a first state, in which the armrest structure 5 assumes the functional position. If, proceeding from this state, the armrest structure 5 is pivoted upward in the direction of the non-use position, for example owing to an acceleration caused by an accident, the detent lug 31 abuts against the detent pin 32 (FIG. 9). A further pivoting of the armrest structure 5 relative to the carrier structure 4 is thus prevented. For the controlled release of the arresting device 30, the control device 34 is provided. Said control device has a sliding-block track 35 formed on the arresting device 30 and a sliding-block pin 36 arranged on the support structure 28. During a relative displacement of the bearing axle 17—and thus of the armrest structure 5—with respect to the support structure 28, the sliding-block pin 36 is displaced along the sliding-block track 35 (FIG. 10). As a result, the detent lug 31 is raised. In this raised position, the detent lug 31 can be moved across the detent pin 32 (FIG. 11). In such a state, the arresting device 30 is released. Proceeding from the position shown in FIG. 11, the armrest structure 5 can, jointly with the support structure 28, be pivoted upward about the pivot axis S relative to the carrier structure 4 in the direction of the non-use position.

1. Armrest arrangement for a motor vehicle seat having a positionally fixed carrier structure, having an armrest structure which is pivotably displaceable relative to the carrier structure about a pivot axis between a functional position and a non-use position, having an inclination adjusting device which is assigned to the armrest structure and which has at least one adjustment element which, in the functional position, is supported at least indirectly on the carrier structure and which is, with respect to an adjustment axis, movable relative to the armrest structure such that the inclination of the armrest structure relative to the carrier structure in the functional position is adjustable by means of an adjustment movement of the adjustment element, wherein the adjustment axis is oriented parallel to the pivot axis, wherein the at least one adjustment element is mounted so as to be rotatable about the adjustment axis and is supported on at least one guide track assigned to the carrier structure.

2. Armrest arrangement according to claim 1, wherein the guide track has a longitudinal extent concentric with respect to the pivot axis.

3. Armrest arrangement according to claim 1, wherein the adjustment element has a spur toothed spur gear portion, and in that the guide track has a toothed rack portion.

4. Armrest arrangement according to claim 1, wherein the adjustment element has a stop portion and in that the guide track has counterpart stop portions arranged at opposite face end regions.

5. Armrest arrangement according to claim 4, wherein the stop portion is, with respect to the adjustment axis, arranged axially offset with respect to the spur gear portion, and in that the counterpart stop portions are arranged equally axially offset with respect to the toothed rack portion.

6. Armrest arrangement according to claim 1, wherein the inclination adjusting device has a blocking device by means of which the adjustment element can be blocked so as to be rotationally fixed about the adjustment axis, and/or in that the inclination adjusting device has a drive device by means of which the adjustment element is subjected to a torque for the displacement along the guide track.

7. Armrest arrangement according to claim 1, wherein two adjustment elements are provided which are spaced apart axially along the adjustment axis and which are each supported on a guide track.

8. Armrest arrangement according to claim 1, wherein a support structure is provided which, in the functional position, is supported on the carrier structure and on which the at least one guide track is formed, wherein the support structure is pivotable jointly with the armrest structure from the functional position into the non-use position.

9. Armrest arrangement according to claim 8, wherein an arresting device is provided which is assigned to the armrest structure and by means of which the armrest structure is, at least in the functional position, arrested on the carrier structure.

10. Armrest arrangement according to claim 9, wherein a control device is provided which is assigned to the arresting device and which is designed such that the arresting device can be released by means of an adjustment movement of the adjustment element.
